(19) United States
(12) Patent Application Publication
(10) Pub. No.: US 2009/0183066 A1
(43) Pub. Date: Jul. 16, 2009

(54) AUTOMATICALLY GENERATING DYNAMIC DOCUMENTATION FROM PRODUCT CONFIGURATION

(76) Inventors: Vanadis Mack Crawford, Raleigh, NC (US); John Edward Petri, Lewiston, MN (US); Leah Rae Smutzer, Rochester, MN (US)

Correspondence Address: MARTIN & ASSOCIATES, LLC, P.O. BOX 548, CARTHAGE, MO, 64836-0548, US

(21) Appl. No.: 12/014,505

(22) Filed: Jan. 15, 2008

(51) Int. Cl. G06F 17/00

(52) U.S. Cl. 715/231

(57) ABSTRACT

A method and apparatus for automatically generating dynamic documentation from a product's configuration related data in a product configuration. A transformation engine incorporates a dynamic documentation mechanism that uses the product configuration file and other information to automatically generate dynamic documentation. In order to automate the creation of dynamic documentation, a new type of annotation element called a “tutorial annotation” is inserted into the product configuration file. The dynamic documentation mechanism provides dynamic documentation such as walk-through tutorials, configuration help, and animations based on the product configuration file and information stored in the tutorial annotations. The dynamic documentation mechanism ascertains a dynamic flow by reading the tutorial annotations and stepping through all of the relationships or dependencies of the product configuration file associated with the software product. The transformation engine then presents the dynamic documentation information in a tutorial fashion (e.g. step by step tutorial using animation).

### BACKGROUND

1. Technical Field

The description and claims herein generally relate to automated documentation of computer software, and more specifically relate to automatically generating dynamic documentation from a product configuration file.

2. Background Art

Technical documentation of modern computer software systems is an important part of the product's development lifecycle and cost. It is very important for the success of the product to document the various details about the product; for example, how the product's user interface functions, what its programming interfaces do, and how its components are installed or deployed. Computer system documentation must be written clearly and in a user friendly way so that a user can quickly understand the aspects of the product that are important to them. However, effectively documenting complex technical products is a daunting task.

In general, many software products today can be configured using extensible markup language (XML). Typically, one or more XML grammars that can be understood or parsed by the product code are developed for the product's configuration data. For example, with some software products, a default configuration is shipped with the product so that the customer can use it “out of the box.” In addition, the customer can develop their own configuration. This results in a couple of different technical documentation requirements. First, since the system's configuration is completely alterable by a customer, the details of the configuration schemas must be exposed. This type of documentation explains to the customer what each element in the schema means and how it could be configured. In addition, documentation is required for the default configuration since some customers will use the default configuration out of the box and need to understand the purpose for each of the default elements defined in the default configuration.

Traditionally, producing technical documentation involved an information development team writing up new information about a product and then publishing that information into “manuals”, on-line help (e.g. context sensitive help within the product's user interface), or information centers when the product ships. In addition, automated documentation systems in the prior art use special annotations embedded within source code so that the documentation can be developed in parallel with the source code and then later be parsed automatically using a program. New information architectures, such as Darwin Information Typing Architecture (DITA), provide means for abstracting and separating product information into a presentation format.

Despite prior art improvements, there remains a need to automatically derive more dynamic documentation from the product's source code and configuration. Further, prior art auto-documentation systems do not adequately address the more complex needs such as interdependent serial flows (e.g. multi-step tutorials involving several inter-related components). Without a way to further automate the documentation process, computer system development will continue to suffer from high documentation costs and lower documentation consistency.

### BRIEF SUMMARY

An apparatus and method is described for automatically generating dynamic documentation from a software product configuration file. The product configuration file may be an XML file, XML schema, document type definition (DTD), or similar configuration file. A transformation engine incorporates a dynamic documentation mechanism that uses the product configuration file and other information to automatically generate dynamic documentation. In order to automate the creation of dynamic documentation, a new type of annotation element called a “tutorial annotation” is inserted into the product configuration file. The dynamic documentation mechanism provides dynamic documentation such as walk-through tutorials, configuration help, and animations based on the product configuration file and information stored in the tutorial annotations. The dynamic documentation mechanism ascertains a dynamic flow by reading the tutorial annotations and stepping through all of the relationships or dependencies of the product configuration file associated with the software product. The transformation engine then presents the dynamic documentation information in a tutorial fashion (e.g. step by step tutorial using animation). For example, the dynamic documentation may be a tutorial for stepping the user through a logical configuration sequence based on a schema and the interdependencies of the schema elements.

The foregoing and other features and advantages will be apparent from the following more particular description, and as illustrated in the accompanying drawings.

### BRIEF DESCRIPTION OF DRAWINGS

The disclosure will be described in conjunction with the appended drawings, where like designations denote like elements, and:

FIG. 1 is a block diagram of a computer system with a transformation engine for automatically generating dynamic documentation from a product's configuration related data;

FIG. 2 is a block diagram of a transformation engine for generating documentation according to the prior art;

FIG. 3 is a block diagram of a transformation engine for automatically generating dynamic documentation from a product's configuration related data;

FIGS. 4 through 6 represent a partial schema file for the tutorial example in FIGS. 8 through 16;

FIG. 7 represents another partial schema file for the tutorial example in FIGS. 17 and 18;

FIGS. 8 through 16 represent a sequence of display screens with a web browser display and a flash player to illustrate an example of a dynamic documentation such as a flash tutorial;

FIGS. 17 through 18 represent a sequence of display screens with a web browser display and a flash player to illustrate another example of a dynamic documentation; and

FIG. 19 is a flow diagram of a method for automatically generating dynamic documentation from a product's configuration related data.

### DETAILED DESCRIPTION

The description and claims herein are directed to an apparatus and method for automatically generating dynamic documentation from a product configuration file that contains a software product's configuration related data. A transformation engine incorporates a dynamic documentation mechanism that provides dynamic documentation such as walk-through tutorials, configuration help, and animations based on the product configuration file and information stored in tutorial annotations. The dynamic documentation mechanism ascertains a dynamic flow by reading the tutorial annotations and stepping through all of the relationships or dependencies of the product configuration file associated with the software product. The transformation engine then presents the dynamic documentation information in a tutorial fashion (e.g. step by step tutorial using animation).

In the prior art, auto-documenting transformation engines used transformations to generate documentation in a particular format; for example, generating documentation based on the Darwin Information Typing Architecture (DITA) standard. DITA provides a way for documentation authors and architects to create collections of typed topics that can be easily assembled into various delivery contexts. Topic specialization is the process by which authors and architects can define topic types, while maintaining compatibility with existing style sheets, transforms, and processes. The new topic types are defined as an extension, or delta, relative to an existing topic type, thereby reducing the work necessary to define and maintain the new type. The point of the XML-based Darwin Information Typing Architecture (DITA) is to create modular technical documents that are easy to reuse with varied display and delivery mechanisms, such as helpsets, manuals, hierarchical summaries for small-screen devices, and so on.

Each configuration file, such as a schema, in a product's configuration set contains information regarding itself (documentation of what it is), how it's used, and any interdependencies (e.g. element A is dependent on how you configure element B, or if you change element B it will affect how element C works, etc.). Some of this information is intrinsic to the defined structure and can be gleaned by the system, while other pieces of information are stored in the form of annotations so additional knowledge about how the configuration file works can be specified without altering its structure. As described herein, additional tutorial information is included as tutorial annotations. The tutorial annotations support the dynamic documentation mechanism to automatically generate for the user dynamic documentation including tutorials based on the configuration file. As used herein, dynamic documentation means documentation that is automatically generated from a software product's configuration file (including product configuration files such as XML files, XML schemas, document type definition (DTD) files, or similar configuration files). Further, as used herein, tutorial annotations mean annotations in the product configuration file that include hints to the dynamic documentation mechanism how to produce associated dynamic documentation for using or configuring the software product associated with the configuration file.

As introduced in the background, some software products have a system configuration that is completely alterable by a customer, so the details of the configuration files must be exposed. Documentation must be provided that explains to the customer what each element in the configuration file means and how it could be configured. Solution for Compliance in a Regulated Environment (SCORE) provided by IBM is such a software product. For example, IBM SCORE uses an action configuration file which defines all of the system's actions (such as checkin, checkout, view, export, etc.). An administrator wanting to customize this file must be very knowledgeable about its structure, possible values, and the various dependencies within and external to the file. Again, complex systems typically require complex configuration. The claims herein are directed to a better way to present documentation to system users, to help them configure and use the system more effectively and efficiently. For example, a Flash tutorial is provided for walking the administrator through the process of configuring a new “action” based on the action configuration schema. Normally the process of creating a new action is a complex task that is prone to manual errors. Generating a tutorial automatically using data from the schema (e.g. both intrinsic and annotated data) allows the user to visualize each step of the process (e.g. with bubble help explaining each step and dependencies), to reduce deployment time and improve customer satisfaction.

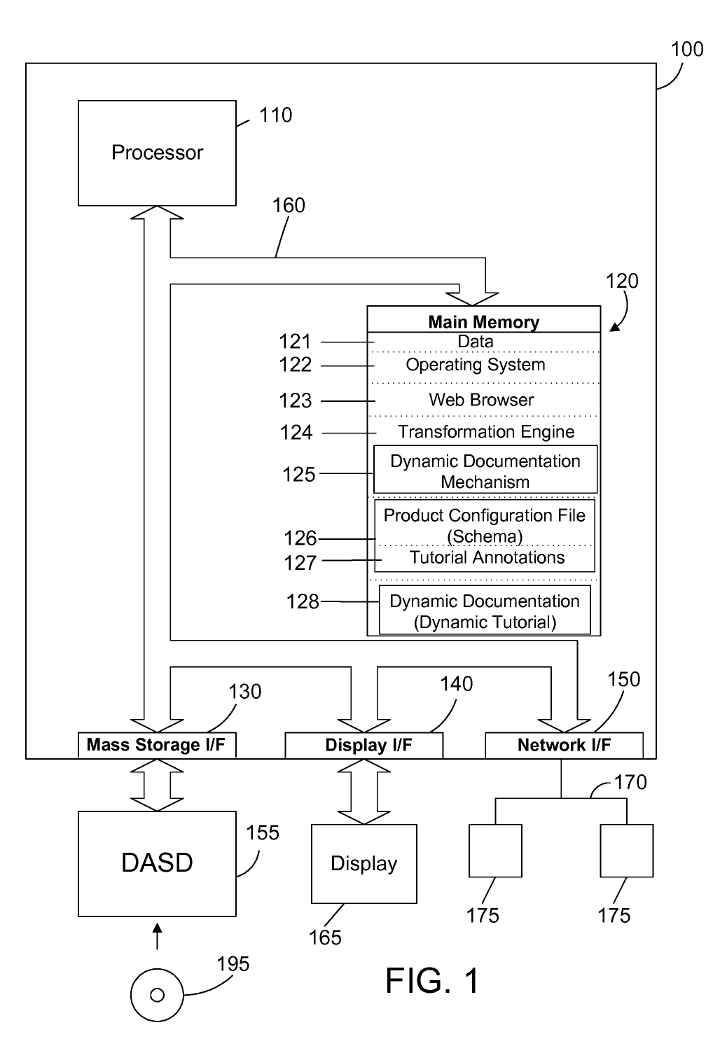

Referring to FIG. 1, a computer system 100 is one suitable implementation of the apparatus and method described herein. Computer system 100 is an IBM System i computer system. However, those skilled in the art will appreciate that the methods and apparatus described herein apply equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system managers are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 contains data 121, an operating system 122, a web browser 123, a transformation engine 124 with a dynamic documentation mechanism 125, a product configuration file (schema) 126 with tutorial annotations 127, and dynamic documentation 128. Data 121 represents any data that serves as input to or output from any program in computer system 100. Operating system 122 is a multitasking operating system known in the industry as i5/OS; however, those skilled in the art will appreciate that the spirit and scope of this disclosure and claims are not limited to any one operating system. Tutorial annotations 127 specify information about how the product configuration file (schema) 126 works without altering the structure of the file. Further, the tutorial annotations 127 may contain example supporting data such as references to outside animations to be included as part of the tutorial.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, web browser 123, transformation engine 124, dynamic documentation mechanism 125, product configuration file (schema) 126, tutorial annotations 127, and the dynamic documentation 128 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Although computer system 100 is shown to contain only a single processor and a single system bus, those skilled in the art will appreciate that the improved transformation engine described herein may be practiced using a computer system that has multiple processors and/or multiple buses.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The dynamic documentation mechanism described herein applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the dynamic documentation mechanism has been and will continue to be described in the context of a fully functional computer system, those skilled in the art will appreciate that the dynamic documentation mechanism described herein is capable of being distributed as an article of manufacture in a variety of forms, and that the claims extend to all types of computer-readable media used to actually carry out the distribution. Examples of suitable computer-readable media include: recordable media such as floppy disks and CD-RW (e.g., 195 of FIG. 1).

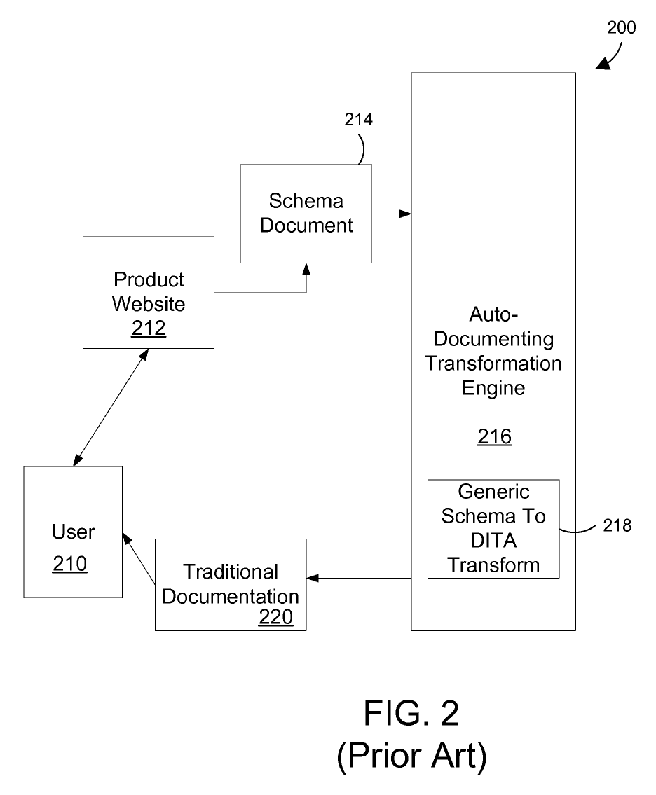

FIG. 2 shows a block diagram of a prior art system for automatically generating documentation. A user 210 can access product information such as on a product website 212. The access to the product website can contribute context information that indicates where in the schema document 214 the user is requesting information. This context information along with the schema document 214 is input to the auto-documenting transformation engine 216. The auto-documenting transformation engine 216 applies the schema document to a generic schema to DITA transform 218 to generate traditional documentation 220. The traditional documentation 220 is any type of documentation known in the prior art.

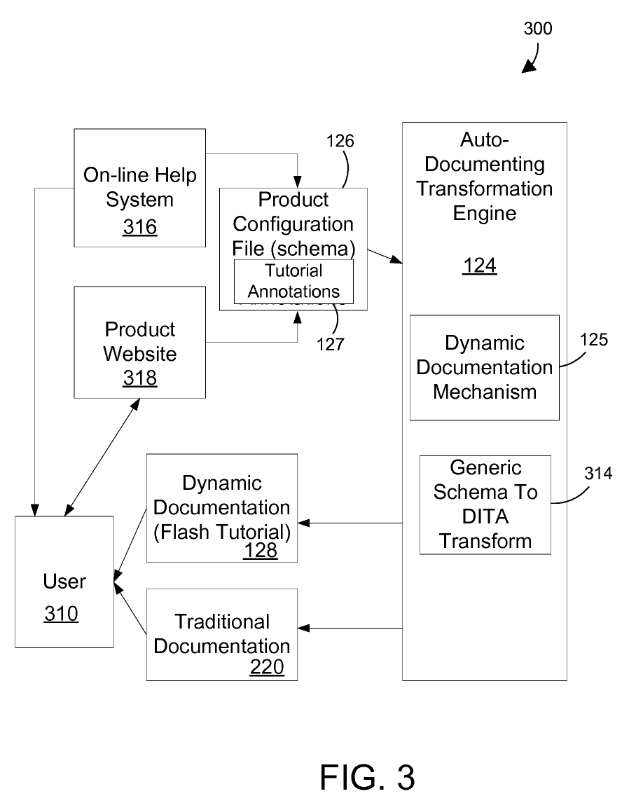

FIG. 3 shows a block diagram 300 of a system for automatically generating dynamic documentation from a product configuration file 126 such as a schema. While the examples herein use a schema for the product configuration file, any reference to schema herein includes other types of configuration files such as XML files, document type definition (DTD) files, or similar configuration files. In order to automate the creation of dynamic documentation, a new type of annotation element called “tutorial annotations” 127 are included in the product configuration file or schema 126. The tutorial annotations are annotations that can be used to give hints how to produce dynamic documentation such as flash tutorials. The schema 126 whose documentation is being requested by the user uses the flow annotations or tutorial annotations 127 to help downstream transformations (e.g. dynamic documentation mechanism) produce the correct documentation output. In response to a user 310 request, the transformation engine 124 reads the schema document 126 with these annotations 127. The dynamic documentation mechanism 125 uses the schema document 126 and tutorial annotations 127 along with deciphering intrinsic information from the schema definition (its structure and some element relationships) to produce the dynamic documentation 128. The dynamic documentation may be presented in a tutorial-like manner and may use flash animation as illustrated in the examples below. The tutorial documentation can be augmented with traditional documentation 220 that may include that generated by prior art techniques from a generic schema to DITA transform 314. Online help system 316 and Product website 318 can be used to provide context information to the auto-documenting transformation engine as described above.

Again referring to FIG. 3, the schema 126 may contain several tutorial annotations 127 with unique names (e.g. “How to create an action”, “How to configure a menu”, etc.). In addition, individual element definitions in the schema can be referenced by name from any tutorial annotation. This allows the element definitions to “participate” in a tutorial. That is, a given step in a tutorial may reference an element definition such that information about the element definition and its annotations are used to add additional content to the tutorial. Finally, “relationship” annotations can be declared to indicate certain semantic relationships (e.g. element A is dependent on how you configure element B, or if you change element B it will affect how element C works, etc.) to the dynamic documentation engine.

The dynamic documentation mechanism 125 also provides a way for the transformation engine to automatically determine which type of output is needed. For this feature, the application that initiates the documentation request (e.g. on-line help, product Website, information center, etc.) can add a processing instruction to the schema to indicate the type of output required. If tutorial output is requested, the processing instruction can also indicate which tutorial(s) in particular has been requested.

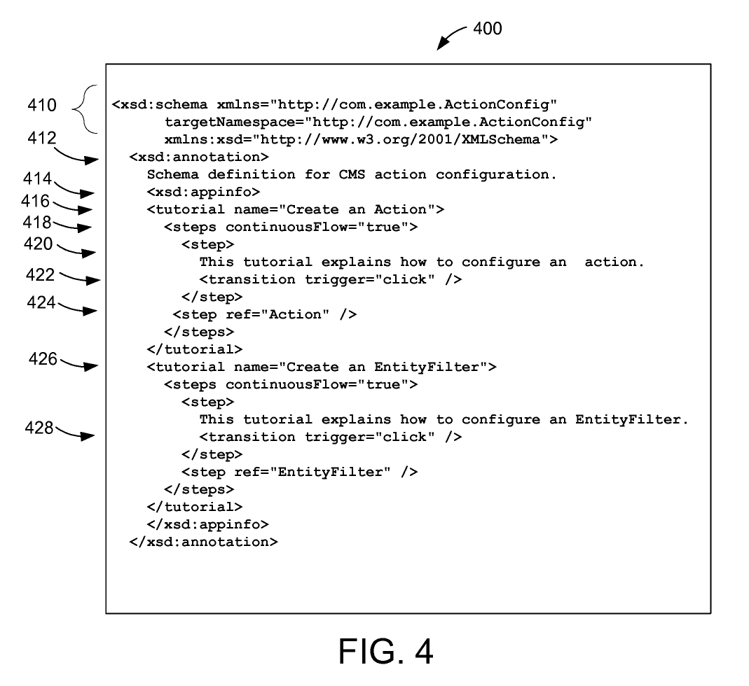

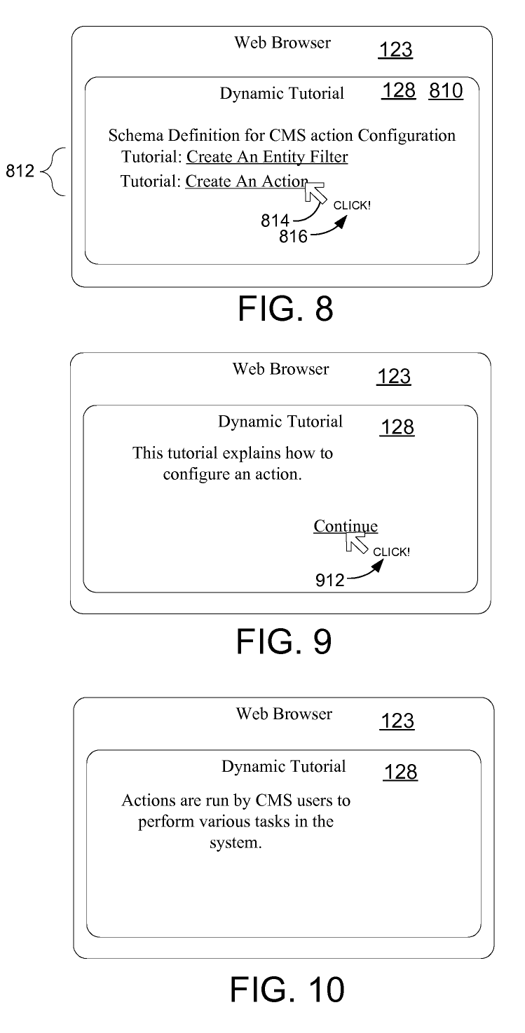

FIGS. 4 through 6 in conjunction with the following paragraphs describe an example schema file that contains tutorial annotations for automatically generating dynamic documentation from a product's configuration related data. While the example herein is described in the context of configuring an “action” in IBM SCORE, the same techniques can be used in other contexts to use tutorial annotations in a schema for dynamic documentation. FIGS. 4 through 7 represent a single schema file 400 that is broken into sections for the drawings and simplified for convenience. FIGS. 4 through 7 represent a partial schema file that includes tutorial annotations to direct the dynamic documentation mechanism to create a dynamic tutorial based on the schema file. A portion of the dynamic tutorial for this schema file is represented in FIGS. 8 through 14 as described below.

Referring to FIG. 4, the first three lines 410 of the schema file 400 include a default namespace, a target namespace and define an “xsd” namespace as shown. A prior art type annotation 412 is then defined as “Schema definition for CMS action configuration.” This annotation is used to introduce the tutorial as described below. An “appinfo” element 414 is defined that contains the tutorial/flow annotations used by the dynamic documentation mechanism (125, FIG. 1) to produce a dynamic tutorial output (128, FIG. 1) or similar suitable animation software output. Tutorial annotations are elements that are included in the schema to provide additional information how the schema works to be used by the dynamic documentation mechanism to produce a dynamic tutorial.

In the example shown in FIG. 4, a tutorial element 416 is created with the name “Create an Action.” The associated tutorial is made up of a series of steps. A tutorial element 418 defines the flow of the steps. Here, “continuous flow=‘true’” means that all of the steps should be shown as a group in the same animation. The text for the first step is “This tutorial explains how to configure an action” 420. A transition element 422 gives the dynamic documentation mechanism a hint as to how the animation should transition between steps. In this case, the transition element 422 indicates the transition trigger is a “click”, meaning a click of the user's mouse, keyboard, or other input device to continue the animation to the next step as described below. The transition element 422 is followed by another step element 424 containing a reference. The step element 424 containing a reference is used to indicate that the tutorial is to process the target schema element as indicated by the reference attribute. In this example, the step element “step ref=‘Action’” 424 indicates that the tutorial is to process the “Action” schema element. The schema 400 further includes another tutorial element named “Create an Entity Filter” 426. This tutorial element 426 is similar to the one described above and also includes a transition trigger 428.

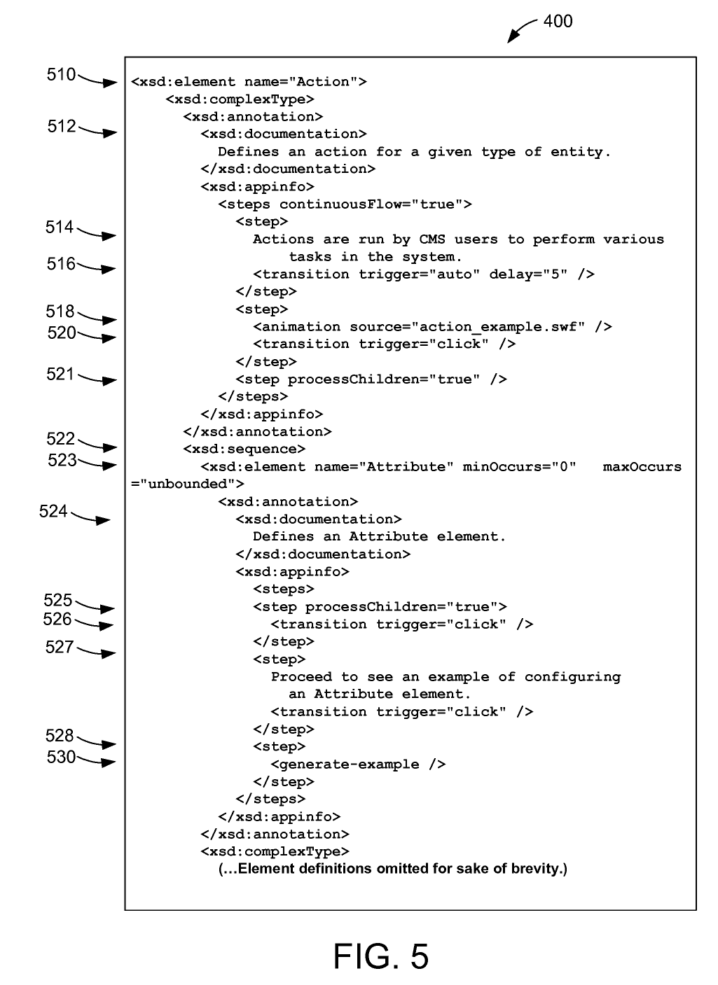

FIG. 5 continues the schema file 400 introduced above with reference to FIG. 4. The section of the schema file 400 in FIG. 5 defines the schema element “Action” 510 referenced in FIG. 4. The Action element 510 includes a documentation element 512 and a step element 514 that provide information about creating an action element. The Action element further includes a transition trigger element 516. This transition trigger element 516 gives a hint to the dynamic documentation mechanism to transition between steps automatically after a five second delay. The Action element 510 further includes an animation source element 518 that indicates a source file for a pre-rendered example that should be displayed as part of this step in the tutorial with a transition trigger 520. A step 521 indicates that the children of this element definition should be processed next in the tutorial. The Action element 510 consists of attribute definitions and child element definitions. The sequence element 522 includes an “Attribute” element 523 with a documentation element 524. The documentation element 524 includes the text “Defines an Attribute element.” The “Attribute” element 523 includes a step 525 that indicates to process each of the children (processChildren=“true”). The next step 526 indicates to the user to “Proceed to see an example of configuring an Attribute element” using the “click” trigger as described above. The next step 528 indicates to “generate an example” 528, which tells the dynamic documentation mechanism that it needs to generate an example based on the schema definition. This generated example based on the schema can be done automatically and thus can reflect any changes that may be made to the schema in the future.

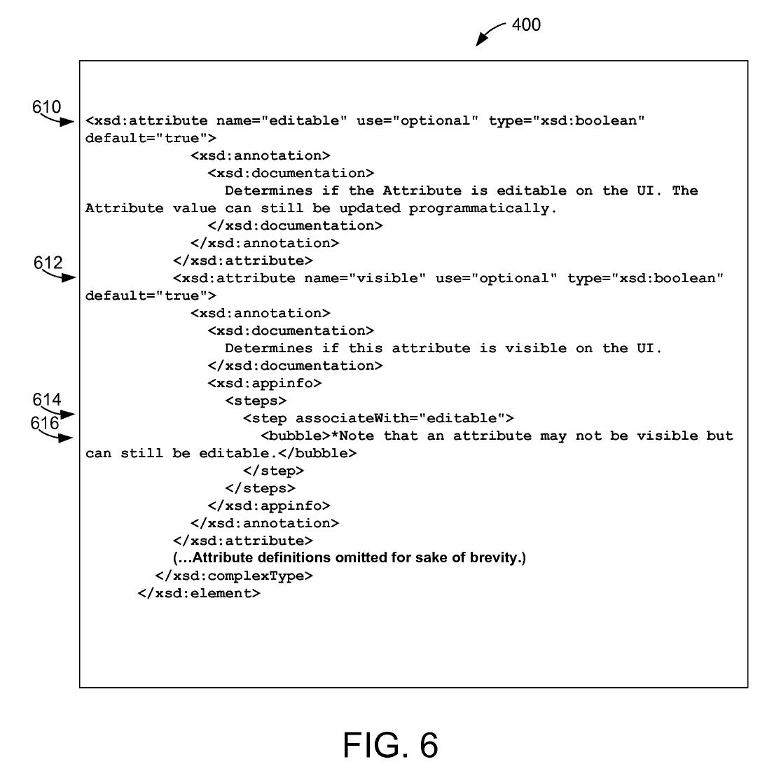

FIG. 6 continues the schema file 400 introduced above with reference to FIGS. 4 and 5. The section of the schema file 400 in FIG. 6 defines the attributes “editable” 610 and “visible” 612 of the Attribute element. The visible attribute 612 includes an “associate with” step 614 and its associated text bubble 616. The “associate with” step 614 identifies a relationship in the schema. In this example, the associate step 614 indicates that the visible attribute 612 is associated with the editable attribute 610. The text bubble 616 gives a text note for the tutorial for this relationship. This associate step identifies a relationship whereby the dynamic documentation mechanism can show the user how to use or respond to this schema elements relationship in the dynamic documentation.

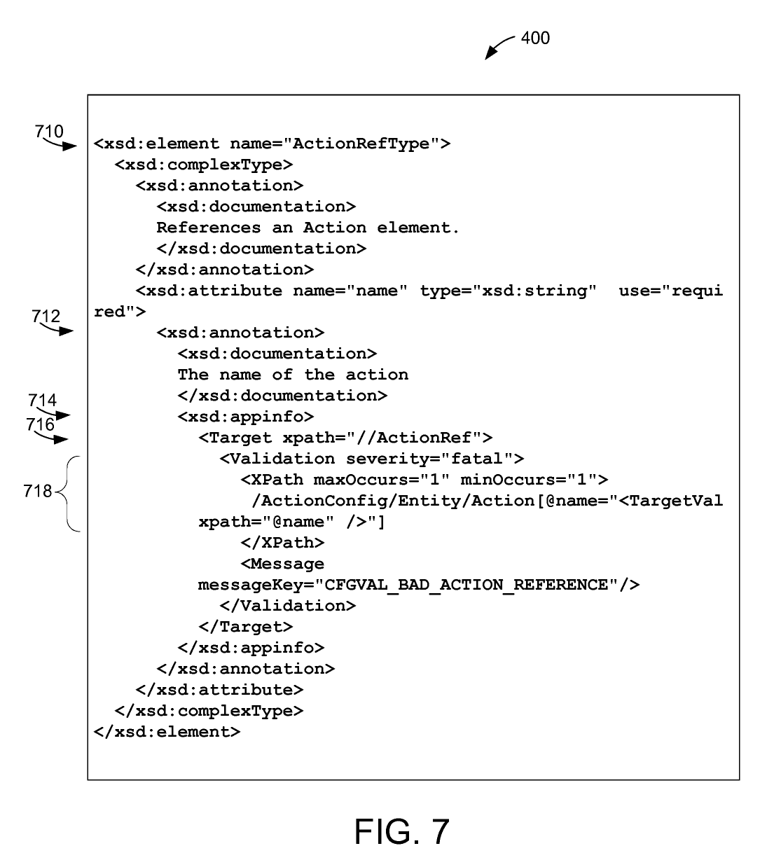

FIG. 7 illustrates another partial schema file 700 similar to the schema file 400 described above. Schema file 700 in FIG. 7 illustrates a small portion of a schema file that introduces an ActionRef element definition 710. An important aspect of this element definition is the information contained under its annotation element 712. There is an appinfo child element 714 of the annotation element 712 which describes extra dependency validation rules that apply to the ActionRef element 712. In other words, the ActionRef element 712 is dependant on another element (in this case Action) in a way described by the dependency validation rules. The target path location “//ActionRef” 716 indicates that the ActionRef element is the target of the dependency validation rule 718. The dynamic documentation mechanism 125 can automatically recognize the presence of such rules and subsequently interrogate them to generate dynamic documentation. For example, the dynamic documentation mechanism 125 may be aware of certain vocabularies used for describing dependency validation rules; for instance if the rules are described using a standard vocabulary. These validation rules could either be included in the schema as shown in FIG. 7 or could be stored externally to the schema. The dynamic documentation associated with this partial schema file 700 is described below with reference to FIG. 17 and FIG. 18.

FIGS. 8 through 16 represent display screens to show an example of automatically generating dynamic documentation such as a dynamic tutorial 128 (FIG. 1) based on the schema file shown in FIGS. 4 through 6. FIGS. 8 through 14 represent a display screen of a computer system (not shown) with a web browser 123. The web browser 123 has a flash player screen 810 displaying the dynamic tutorial 128. Subsequently, references to the screen displays in FIGS. 8 through 14 mean the dynamic tutorial 128 as displayed to the user. Displaying the dynamic tutorial on a flash player in a browser is one way to present the dynamic documentation to a user in a tutorial manner. While the examples herein are described in the context of a flash tutorial, other suitable applications could be used to view the dynamic documentation in a tutorial like fashion as described herein.

The dynamic tutorial 128 on the flash player screen 810 may be displayed as a result of a user accessing a product website for information about configuring a software product. In this example, flash player screen 810 would be displayed in response to the user seeking documentation for creating an action in IBM SCORE as described above. Tutorial flash player screen 810 is dynamically produced by the dynamic documentation mechanism 125 (FIG. 1) based on the schema file 400 (FIGS. 4 through 6) and passed to the flash player for display. The process of the dynamic documentation mechanism producing the dynamic tutorial by examining the schema file 400 will be explained for each of the display screens shown in FIGS. 8 through 14. References to the schema in the following paragraphs, items 410 through 616, can be found in FIGS. 4 through 6.

Again referring to FIG. 8, the dynamic documentation mechanism 125 (FIG. 1) analyzes the schema file 400 and determines there are two tutorials 416, 426 that can be selected by the user. The dynamic documentation (tutorial) 128 (FIG. 1) for the display screen 810 is then created to show the two choices 812. Each of the tutorials 416, 426 have a “Click” transition trigger 422, 428. A transition trigger is an instruction to the dynamic documentation mechanism to create a transition in the tutorial. A “click” transition trigger means to use a click of the cursor or other input device by the user to move the tutorial to the next section. In this example, the tutorial allows the user to select one of the two options using a cursor 814. The cursor 814 may be moved in the normal manner using a mouse or joystick (not shown). The user makes the selection by hitting a select button as represented by the “Click” 816 on the display screen 810.

In response to the user's selection of “Create An Action” with the cursor 814 in FIG. 8, the dynamic tutorial 128 would then display the tutorial 128 as shown in FIG. 9. The tutorial 128 in FIG. 9 shows the first step of the “Create An Action” tutorial 416. The schema 400 indicates that the transition trigger 422 is of type “click” so the tutorial as shown in FIG. 9 waits for a “click” 912 by the user to continue.

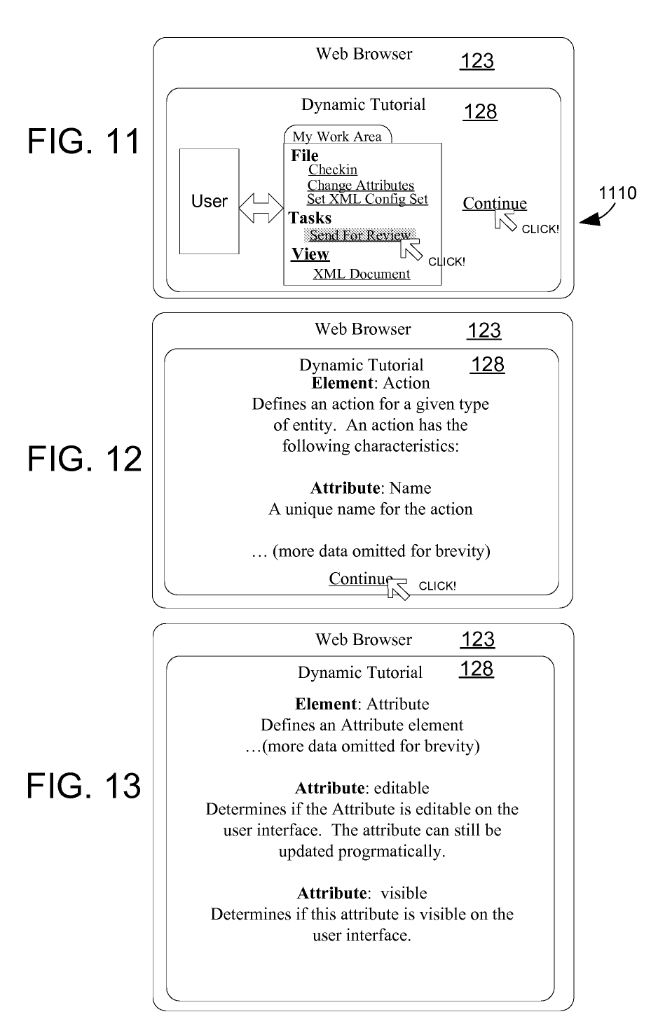

FIG. 10 shows the dynamic tutorial 128 after the user clicked “Continue” as shown in FIG. 9. The tutorial in FIG. 10 is generated from the first step 514 of the “Action” 510 for five seconds as indicated by the transition trigger 516 (FIG. 5). After five seconds, the tutorial will go to the next step 518. Step 518 indicates to run an animation file called “action_example.swf”. The display corresponding to this animation file is represented in FIG. 11. The animation is used to give further details at this point in the tutorial, which in this case is depicting how an action is executed by a user of the system. After the animation is complete, the user is able to click on the continue 1110 as shown to continue to the next part of the tutorial. This action is supported by the transition trigger 520 in the schema file 400.

FIG. 12 shows information about the Action element definition and its children as indicated by the “step processChildren=‘true’” element 521 in FIG. 5. FIG. 12 shows only a description of the Action element and its attributes. The user can continue to view information about all of the element's children by clicking “Continue”.

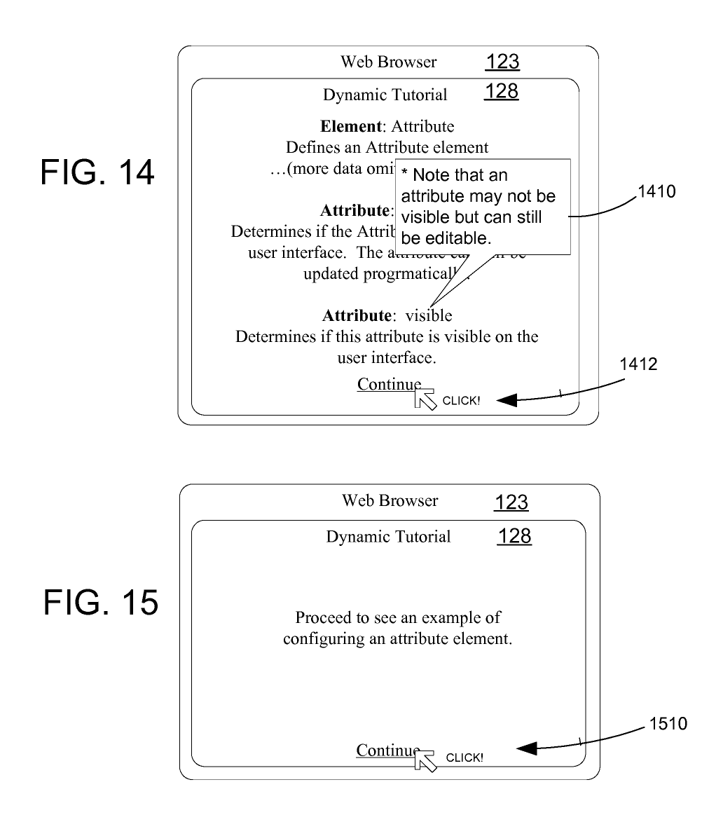

The tutorial display in FIG. 13 is generated by the dynamic documentation mechanism from the sequence 522 that includes the element “Attribute” 523, its documentation 524, and documentation from its defined attributes. The step “processChildren=true” indicates to the dynamic documentation mechanism to generate the display as shown in FIG. 13. After the display in FIG. 13 is shown, the dynamic documentation mechanism may then show the display as shown in FIG. 14 to illustrate the element relationship described in FIG. 6. The attributes shown in FIG. 13 and described in FIG. 6 include a relationship defined by an “associate with” step 614. As described above with reference to FIG. 6, the attribute visible 612 is associated with the attribute editable 610 by the associate step 614. The bubble note 1410 in FIG. 14 from the step 616 is used to tell the user of this relationship. The transition trigger 526 is then used by the dynamic documentation mechanism to indicate to the user to continue 1412 to the next section of the tutorial.

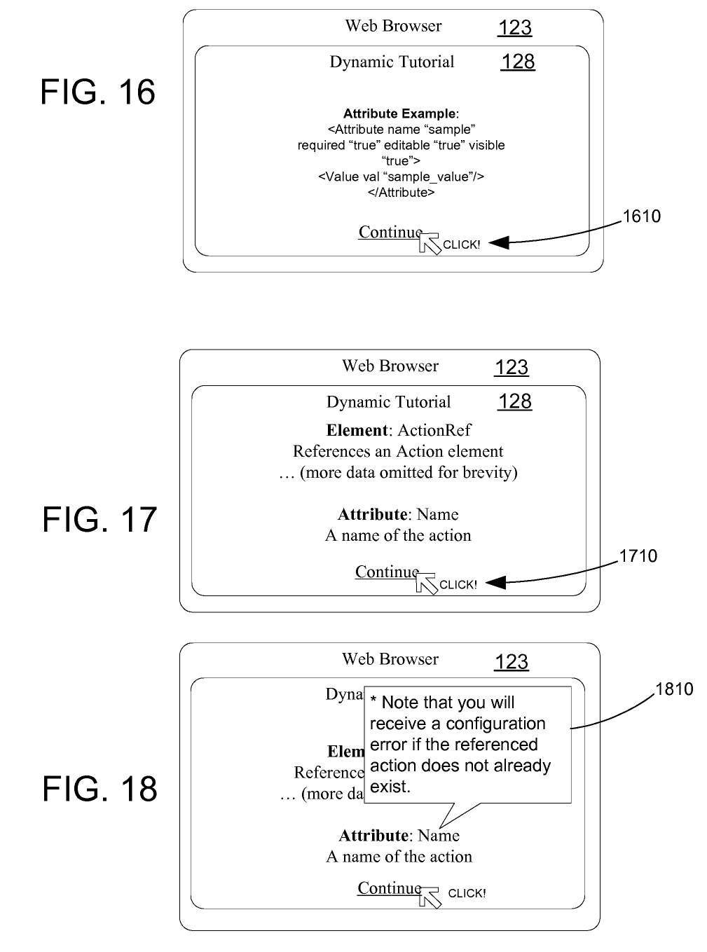

FIG. 15 corresponds to step 527 (FIG. 5), which indicates to the user that clicking continue will generate an example. Step 528 (FIG. 5) generates an example 530 by examining the schema for an attribute example. The generated example 530 is displayed in the tutorial as shown in FIG. 16. In this case, the attributes “name”, “required”, “editable”, and “visible” 610 are extracted from the schema 400. The click trigger 1610 is used to continue the tutorial. However, support for this trigger in the example schema is not shown.

FIGS. 17 and 18 represent display screens to show another example of automatically generating dynamic documentation 128 (FIG. 1) such as a tutorial or flash tutorial. This example is based on the partial XML schema file shown in FIG. 7. FIG. 17 shows how the dynamic documentation mechanism interprets information from the supplied dependency validation rule as discussed above. It determines from the rule that the ActionRef element is dependant on the Action element. As such, it shows additional bubble help during the tutorial flow to help the user better understand the dependency. In this example, we show how the “ActionRef” element 710 as defined in schema 700 (FIG. 7) is included in a tutorial. The dynamic documentation for the “ActionRef” element 710 would be generated as shown in FIG. 17 in the same manner as described above. FIG. 18 represents the same display screen shown in FIG. 17 after the user has “clicked” on continue 1710 (FIG. 17). The bubble 1810 indicates to the user a warning of a potential pitfall when configuring an element of this type based on the element definition's dependency validation rule. In this example, the bubble 1810 warns the user that a configuration error will result if the referenced action does not already exist before the user reaches this point in the configuration process according to the dependency validation rules. In this manner, the dynamic documentation mechanism changes the tutorial based on dependencies in the schema architecture and the requirements of the schema configuration.

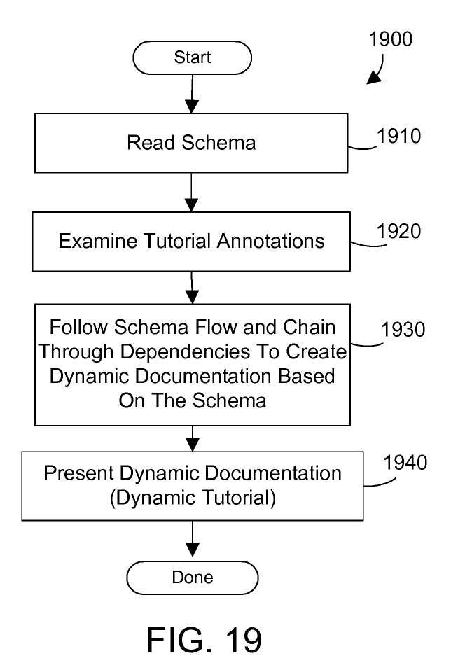

FIG. 19 shows a method 1900 for automatically generating dynamic documentation from an XML schema file with tutorial annotations. The steps in method 1900 are typically performed by a computer system. First, read an XML schema (step 1910). Next, read through the schema to examine the tutorial annotations (step 1920). Follow the flow of the schema and chain through the dependencies to create dynamic documentation based on the schema (step 1930). And then present a tutorial to the user based on the flow and dependencies in the schema using the tutorial annotations (step 1940). The method is then done.

One skilled in the art will appreciate that many variations are possible within the scope of the claims. Thus, while the disclosure has been particularly shown and described above, it will be understood by those skilled in the art that these and other changes in form and details may be made therein without departing from the spirit and scope of the claims.

What is claimed is:

1. A computer system comprising:
a computer processor with associated memory;
a product configuration file with tutorial annotations residing in the memory and associated with a software product, wherein the tutorial annotations provide hints how to produce dynamic documentation; and
a transformation engine executing on the computer processor, wherein the transformation engine comprises a dynamic documentation mechanism that uses the tutorial annotations to automatically generate the dynamic documentation for a software product associated with the product configuration file.

2. The computer system of claim 1 wherein the product configuration file is chosen from the following: extensible markup language (XML) file, schema file, document type definition (DTD) file.

3. The computer system of claim 2 wherein the dynamic documentation is a tutorial for using software associated with the product configuration.

4. The computer system of claim 3 wherein the tutorial annotations provide hints of schema element relationships.

5. The computer system of claim 4 wherein the hints are used in the tutorial to warn the user of potential pitfalls in configuring and using the software product.

6. The computer system of claim 1 wherein the dynamic documentation mechanism provides tutorial documentation from self validation rules.

7. The computer system of claim 6 wherein the self validation rules provide relationships for schema elements to give user hints in the tutorial documentation.

8. The computer system of claim 6 wherein the self validation rules are referenced external to the schema.

9. A computer implemented method for producing dynamic documentation, the method comprising the steps of:
reading a product configuration file with tutorial annotations;
examining the product configuration file to process the tutorial annotations;
creating dynamic documentation based on the product configuration file and the tutorial annotations; and;
presenting the dynamic documentation to a user.

10. The computer implemented method of claim 9 wherein the step of creating dynamic documentation further comprises the steps of: stepping through attributes and relationships in the product configuration file to create dynamic documentation that illustrates these relationships to the user.

11. The computer implemented method of claim 9 wherein the dynamic documentation is a tutorial for using software associated with the product configuration file.

12. The computer implemented method of claim 11 wherein the tutorial is a flash tutorial with flash animations.

13. The computer implemented method of claim 9 wherein the tutorial annotations provide hints of element relationships that are used in the tutorial to warn the user of potential pitfalls in configuring a software product associated with the product configuration file.

14. A computer implemented method for producing dynamic documentation, the method comprising the steps of:
reading a schema with tutorial annotations;
following the schema flow and chaining through dependencies to process the tutorial annotations in the schema;
creating a flash tutorial with animations based on the schema and the tutorial annotations, wherein the tutorial annotations provide hints of schema element relationships that are used in the tutorial to warn the user of potential pitfalls in configuring a software product associated with the schema; and
presenting the flash tutorial to a user.

15. A computer-readable article of manufacture comprising:
a schema file with tutorial annotations associated with a software product;
a transformation engine executing on the computer processor, wherein the transformation engine comprises a dynamic documentation mechanism that uses the tutorial annotations to generate dynamic documentation associated with the schema file; and
tangible computer recordable media bearing the transformation engine.

16. The article of manufacture of claim 15 wherein the dynamic documentation is a tutorial for using software associated with the schema.

17. The article of manufacture of claim 15 wherein the tutorial annotations provide hints of schema element relationships.

18. The article of manufacture of claim 15 wherein the dynamic documentation mechanism provides tutorial documentation in the form of user hints from self validation rules.

19. The article of manufacture of claim 18 wherein the self validation rules provide relationships for schema elements to give user hints in the tutorial documentation.

20. The article of manufacture of claim 18 wherein the self validation rules are referenced external to the schema.
